(19) United States
(12) Patent Application Publication
(10) Pub. No.: US 2004/0220034 A1
(43) Pub. Date: Nov. 4, 2004

(54) Method and apparatus for manufacturing a resealable package

(76) Inventors: Greg W. Melchoir, Green Bay, WI (US); Greg J. VandenHeuvel, Kaukauna, WI (US); Wes W. Fietzer, Appleton, WI (US); James E. Buchman, Hortonville, WI (US)

Correspondence Address: Tracey D. Beiriger, Alcoa Technical Center, 100 Technical Drive, Alcoa Center, PA, 15069-0001, US

(21) Appl. No.: 10/427,716

(22) Filed: Apr. 30, 2003

(51) Int. Cl. B31B 1/84

(52) U.S. Cl. 493/213; 53/412

(57) ABSTRACT

A method of making a resealable package is provided. The method comprises providing a closure mechanism, the closure mechanism comprising first and second closure profiles, the first and second closure profiles constructed and arranged to selectively engage, and wherein the first and second closure profiles are engaged. The method further comprises providing a pair of panels comprising a flexible polymeric material, inserting a wedge between the closure profiles, disengaging the closure profiles; and attaching the closure mechanism to the pair of side panels. Various embodiments of opening devices are also presented.

### FIELD OF THE INVENTION

The present invention relates generally to a method of making polymer packages, for example, plastic bags. In particular, the present invention relates to a methods and apparatuses relating to closure mechanisms for a resealable bag.

### DISCUSSION OF RELATED ART

Many packaging applications use resealable containers to store various types of articles and materials. These packages may be used to store and ship food products, non-food consumer goods, medical supplies, waste materials, and many other articles. Resealable packages are convenient in that they can be closed and resealed after the initial opening to preserve the enclosed contents. The need to locate a storage container for the unused portion of the products in the package is thus avoided. As such, providing products in resealable packages appreciably enhances the marketability of those products.

Resealable packages typically utilize a closure mechanism that is positioned along the mouth of the package. The closure mechanism often comprises profile elements or closure profiles that engage one another when pressed together. Typically a slider device used for opening the closure mechanism is attached to the closure mechanism while the closure profiles are disengaged. This facilitates filling of the package with product after the slider is attached. However, attaching the slider to a closure mechanism in an open state results in difficulty in handling and aligning the pair of closure profiles during manufacturing. If the slider device is attached to the closure mechanism while the closure mechanism is closed, the closure mechanism must be opened before the package can be filled. Prior methods of opening the closure mechanism, including manually opening the closure mechanism, have proved to be inefficient from a manufacturing standpoint.

It is therefore desirable to attach the slider device to the closure mechanism while the closure mechanism is in a closed state, and to provide a method and apparatus for automatically opening the closure mechanism after the slider device has been attached. Alternately, the slider device may be attached after the closure mechanism has been opened. Further, the opening methods and apparatus of the present invention can be applied to a closure mechanism without a slider, such as a traditional “press-to-close” zipper.

### SUMMARY OF THE INVENTION

In accordance with the present invention, a method of making a resealable package is provided. The method comprises providing a closure mechanism, the closure mechanism comprising first and second closure profiles, the first and second closure profiles constructed and arranged to selectively engage, and wherein the first and second closure profiles are engaged. The method further comprises providing a pair of panels comprising a flexible polymeric material, providing a means to open the closure profiles, such as inserting a wedge between the closure profiles, to disengage the closure profiles; and attaching the closure mechanism to the pair of side panels. The opening of the closure profiles and attachment of the closure mechanism to the side panels may occur substantially simultaneously.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

The various features and benefits of the present invention are apparent in light of the following detailed description and the accompanying drawings, in which:

FIG. 1 is a perspective view of a flexible, resealable package manufactured in accordance with an embodiment of the present invention.

FIG. 2 is a schematic view of a process of manufacturing a resealable package in accordance with an embodiment of the present invention.

FIG. 3 is a perspective view of a slider attachment device and a device for opening a closure mechanism used in accordance with an embodiment of the present invention.

FIG. 4a is a top view of the device for opening a closure mechanism illustrated in FIG. 3.

FIG. 4b is an elevated, side view of the device for opening a closure mechanism illustrated in FIG. 3.

FIG. 4c is an alternate perspective view of the device for opening a closure mechanism illustrated in FIG. 3.

FIG. 4d is an cross-sectional view of the device for opening a closure mechanism illustrated in FIG. 3 taken along line 4d-4d (shown in FIG. 4b).

FIG. 5 is an elevated, side view of a alternate device for opening a closure mechanism used in accordance with an embodiment of the present invention.

FIG. 6a is an elevated, side view of a wedge used as part of the device for opening a closure mechanism illustrated in FIG. 5.

FIG. 6b is an elevated, end view of a wedge used as part of the device for opening a closure mechanism illustrated in FIG. 5.

FIG. 6c is a perspective view with a cross-sectional view insert showing an alternate embodiment of a wedge that can be used in conjunction with the apparatus and methods described herein.

FIG. 6d is a schematic frontal view of the plow and guide legs of the wedge shown in FIG. 6c.

FIG. 6e is a perspective view showing the relational position between the wedge of FIG. 6c and a closure mechanism prior to opening the closure mechanism.

FIG. 6f is a perspective view showing the wedge of FIG. 6c passing into a closure mechanism to separate the closure profiles thereby opening the closure mechanism.

FIG. 7 is an elevated, side view of the device for opening a closure mechanism illustrated in FIG. 5, illustrating its operation.

FIG. 8 is an elevated, side view of a alternate device for opening a closure mechanism used in accordance with an embodiment of the present invention.

FIG. 9 is a top view of the device for opening a closure mechanism illustrated in FIG. 8.

FIG. 10a is an end view of the device for opening a closure mechanism illustrated in FIG. 8.

FIG. 10b is an end view of the device for opening a closure mechanism illustrated in FIG. 8, illustrating the use of sealing bars in accordance with an embodiment of the present invention.

FIGS. 11a-c are cross-sectional views of an opening device and method that employ a perpendicular external force to open a closure mechanism.

FIG. 12 is a cross-sectional view of an opening device and method that use a channel wedge to open a closure mechanism.

### DETAILED DESCRIPTION OF THE INVENTION

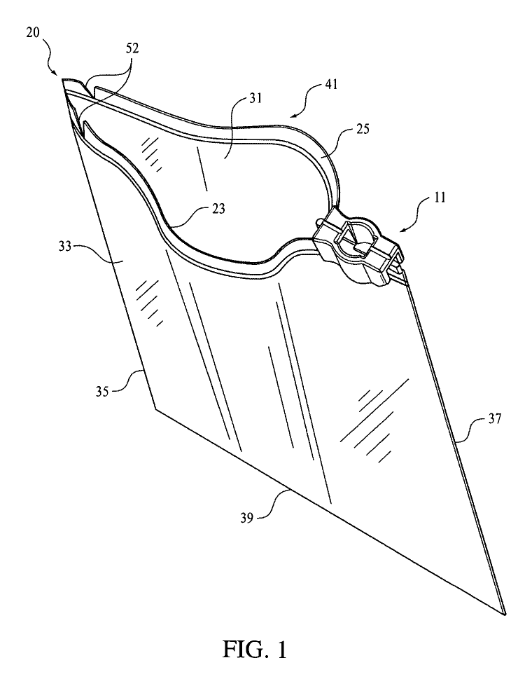

FIG. 1 illustrates an example of a resealable, flexible package 20 having a closure mechanism 41 with first and second closure profiles 23, 25 and a slider device 11 to open and close the profiles 23, 25.

The resealable package 20 includes first and second opposed panel sections 31, 33 made from a flexible, polymeric film. For some manufacturing applications, the first and second panel sections 31, 33 are heat-sealed together along two edges 35, 37 and meet at a fold line 39 in order to form a three-edged containment section for a product within the interior of the package 20. The fold line comprises the bottom edge 39. Alternatively, two separate panel sections 31, 33 of polymeric film may be used and heat-sealed together along the two edges 35, 37 and at the bottom 39.

The resealable package 20 also includes a closure mechanism 41 made in accordance with an embodiment of the present invention. The closure mechanism 41 includes first and second closure profiles 23, 25. The first and second closure profiles 23, 25 may be of any appropriate design known in the art. Example closure profiles are disclosed in U.S. Pat. Nos. 5,983,466, 5,947,603, and 6,217,215.

In certain embodiments, a slider device 11 is mounted on the closure mechanism 41 to facilitate the opening and closing of the closure mechanism 41. Slider devices and how they function to open and close such mechanisms, in general, are taught, for example, in U.S. Pat. Nos. 5,063,644, 5,301,394, 5,442,837 and 5,664,229, each of which is incorporated by reference herein, in its entirety. A preferred slider device is taught in U.S. Pat. Nos. 6,293,701 and D434,345 each of which is incorporated by reference herein, in its entirety.

In embodiments that include a slider device, a notch 52 is preferably disposed within the closure mechanism 41. The notch 52 is designed to provide a “park place” into which the slider 11 settles when the closure mechanism 41 is sealed. The notch 52 decreases the chances of an incomplete interlock between the first and second closure profiles 23, 25. Example notches are disclosed, for example, in U.S. Pat. Nos. 5,067,208 and 5,301,395, each of which is incorporated by reference herein, in its entirety.

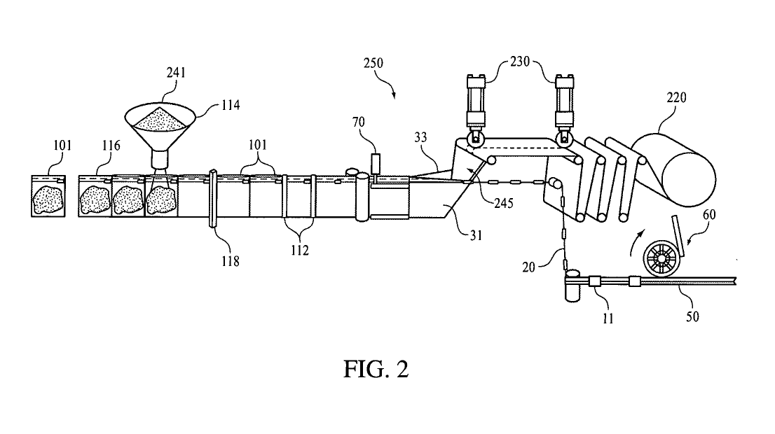

FIG. 2 illustrates a schematic example of a horizontal form, fill and seal (“HFFS”) process for manufacturing a resealable package 20 in accordance with the present invention. The HFFS process described in U.S. Pat. No. 6,293,896, which is incorporated by reference herein, in its entirety, is substantially similar to that described and shown herein with the obvious variation that the package of the present invention is inverted (i.e. the formation and filling in the present invention is from the top) whereas the formation and filling in the '896 patent occurs from the bottom. The first and second closure profiles 23, 25 (not shown individually in FIG. 2) are provided in an engaged configuration as a continuous length of closure profile material 50. Preferably, the closure mechanism material 50 is provided on a roll (not shown). The closure mechanism material 50 is unwound and fed to the HFFS process.

The slider 11 is attached to the closure mechanism material 50 by a slider application station 60. The slider application station 60 applies the slider 11 to the closure mechanism material 50 through the use of any appropriate means known in the art, for example, the apparatuses as described in U.S. Pat. Nos. 6,199,256 and 6,293,896, each of which are hereby incorporated by reference herein, in its entirety. The slider application station 60 may also be used to notch the closure profile material in order to provide the notch 52 (as shown in FIG. 1), as disclosed in U.S. Pat. No. 6,199,256.

After the slider 11 is applied to the closure mechanism material 50, the closure mechanism material 50 passes to the HFFS machine 250. The material that comprises the side panels 31, 33 of resealable package 20 (as shown in FIG. 1) is provided on a roll 220. The material is unwound and may optionally pass to perforators 230 that score the material to facilitate later removal of a header section 101. The material then passes over a folding board 245 (as is known in the art) to form the two side panels 31, 33. The folding board 245 may include a slitter (not shown), if e.g. the HFFS machine is operated in a different orientation.

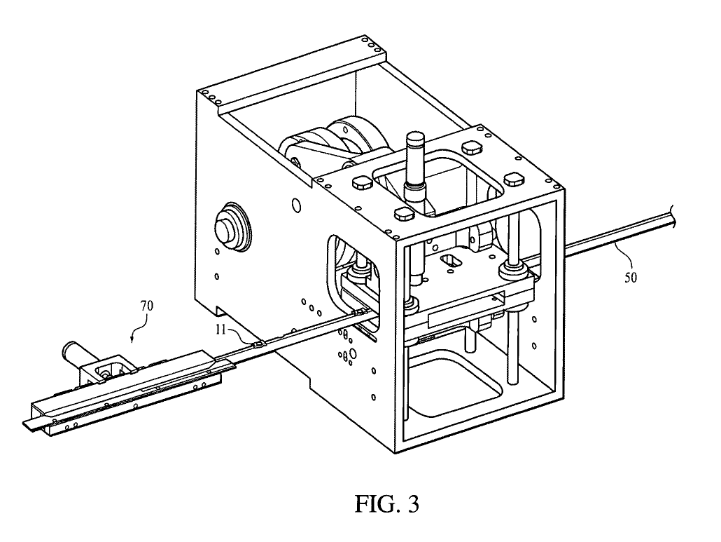

In the embodiments of the invention illustrated in FIGS. 3-8, the first and second closure profiles 23, 25 are disengaged by the closure mechanism opening apparatus 70 prior to the closure mechanism material 50 being attached to the first and second side panels 31, 33. Alternately, the closure mechanism may be disengaged substantially simultaneously with the closure mechanism being attached to the side panels (i.e. disengagement and attachment as a single step), or disengagement may even occur after attachment to the side panels.

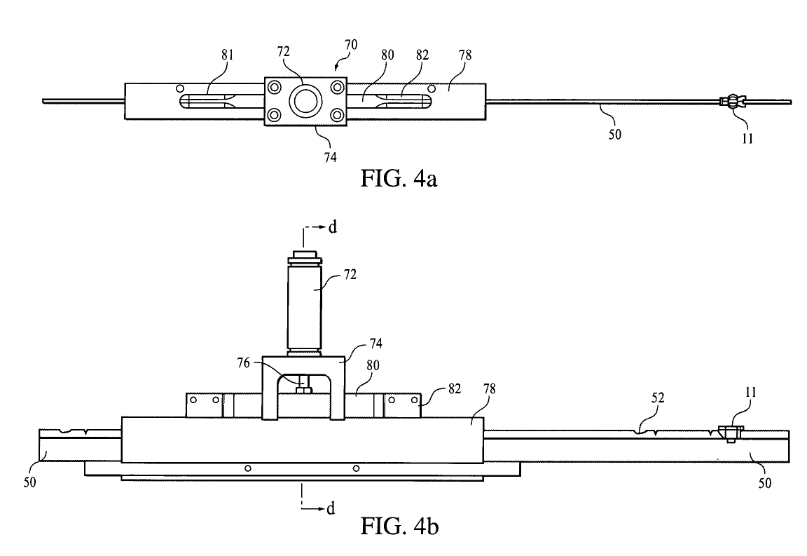

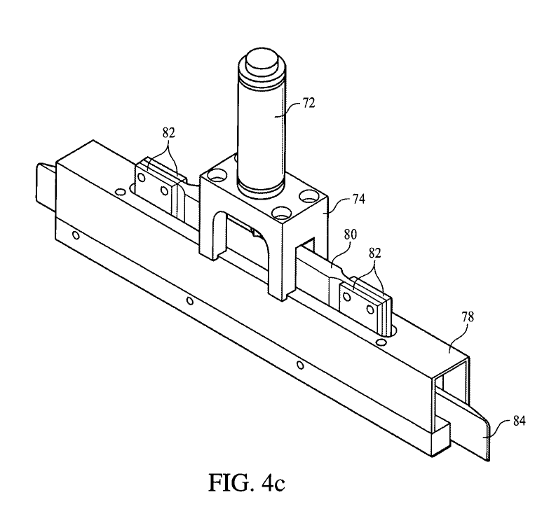

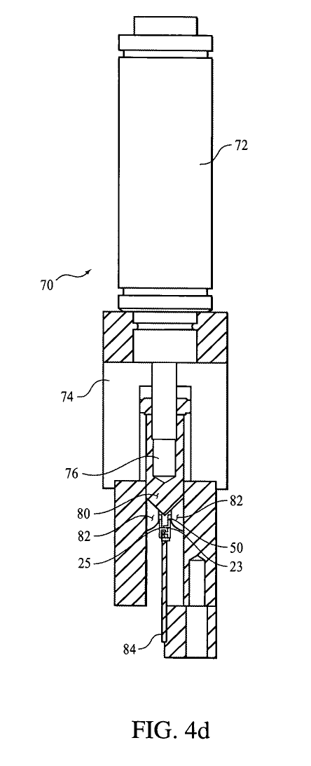

An example closure mechanism opening apparatus 70 is illustrated in FIGS. 4a-4d. The closure mechanism opening apparatus 70 comprises a rod 76 and a piston 72 that causes selective reciprocating movement of the rod 76. A preferred rod 76 and piston 72 are manufactured by DE-STA-CO Industries, 31791 Sherman Drive, Madison Heights, Mich. 48071, Model 816, made of steel and aluminum. The rod 76 and piston 72 are preferably mounted on a stand-off base 74.

The rod 76 is operably connected to a wedge 80 such that as rod 76 moves, the wedge 80 moves. For example, if the piston is activated to move the rod in a reciprocating manner, the wedge would move in a similar manner. As best shown in FIG. 4d, the wedge 80 is preferably tapered along its bottom edge to allow it to penetrate between the closure profiles 23, 25. A set of guide members 82 are attached at both ends of the wedge 80. The guide members 82 act to align the closure mechanism material 50 as it passes through the closure mechanism opening apparatus 70. The guide members 82 are preferably designed and arranged to allow the closure mechanism material 50 to pass between them and align the closure mechanism material 50 beneath the wedge 80 or in similar proximity to the wedge, depending on the spatial orientation of apparatus 70. The guide members 82 are attached to the wedge 80 by any means known in the art, for example, by machined screws or by welding. Alternatively, the wedge 80 and guide members 82 may be formed integrally.

The closure mechanism opening apparatus 70 further comprises a three-sided guide channel 78. The guide channel 78 preferably has a support blade 84 attached to one of its sides as best seen in FIG. 4d. The stand-off base 74 is attached to the top of guide channel 78, which has an aperture 81 through its top side as shown in FIG. 4a. In this way, the selective reciprocating movement of the rod 76 causes the wedge 80 and guide members 82 to move up and down through the aperture 81 in the top of the guide channel 78.

Preferably, the closure mechanism opening device 70 further includes a support blade 84 that is designed and arranged such that when the closure mechanism material 50 passes through the guide channel 78, the closure mechanism material 50 straddles or rides on the blade 84, which supports the closure mechanism material 50. As stated previously, the blade 84 preferably assists in aligning the closure mechanism material 50 beneath the wedge 80.

In operation, a length of the closure mechanism material 50 that corresponds to the length of a resealable package 20 passes into the guide channel 78, on top of blade 84. The progress of the closure mechanism material 50 is stopped. The piston 72 is then actuated whereby the rod 76 is extended. This causes the wedge 80 and guide members 82 to be moved through the aperture 81 of the top of the guide channel 78. The guide members 82 are forced along the outside of the closure mechanism material 50, and the wedge 80 is disposed between the closure profiles 23, 25. As the wedge 80 is moved downward by the rod 76, the wedge 80 forces closure profiles 23, 25 to disengage along the length of the wedge 80. The wedge 80 is then withdrawn from the closure mechanism material 50. The opened closure mechanism material 50 is then advanced in an opened state for further processing, as is described below.

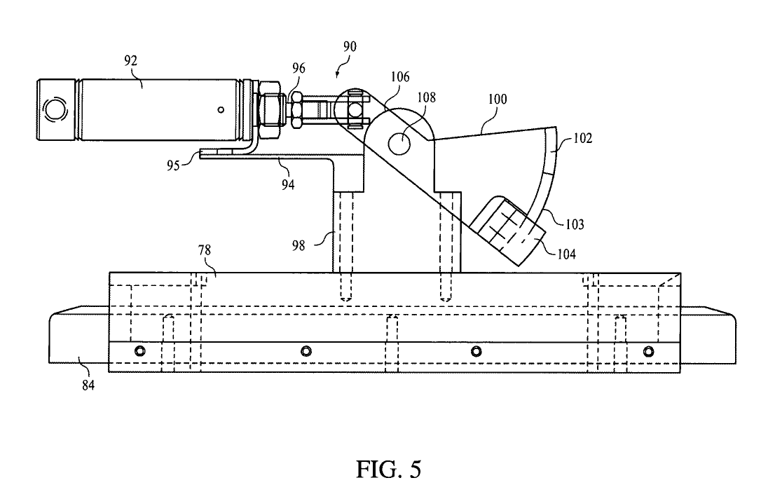

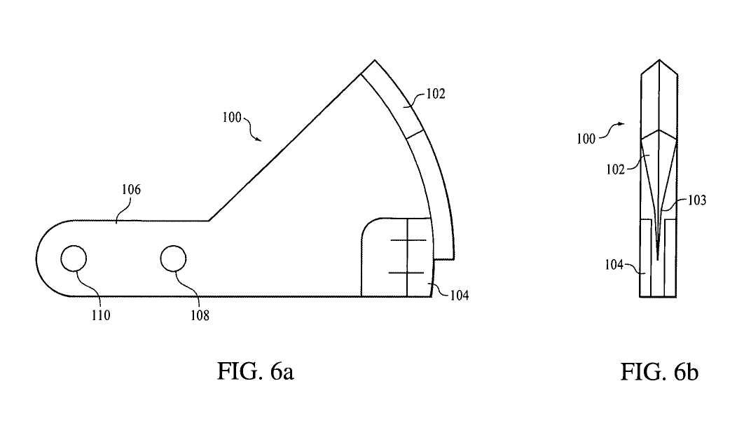

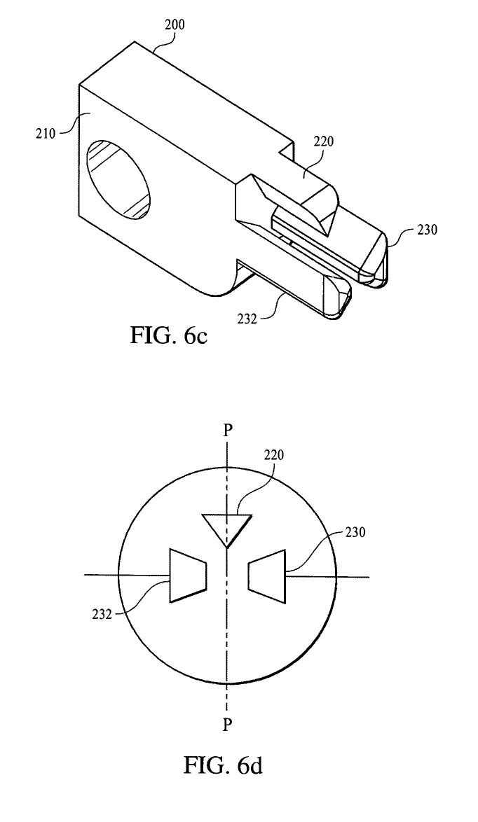

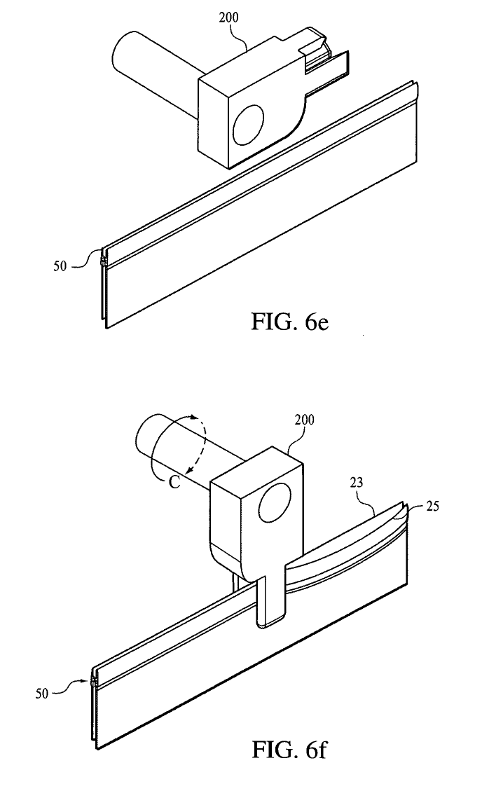

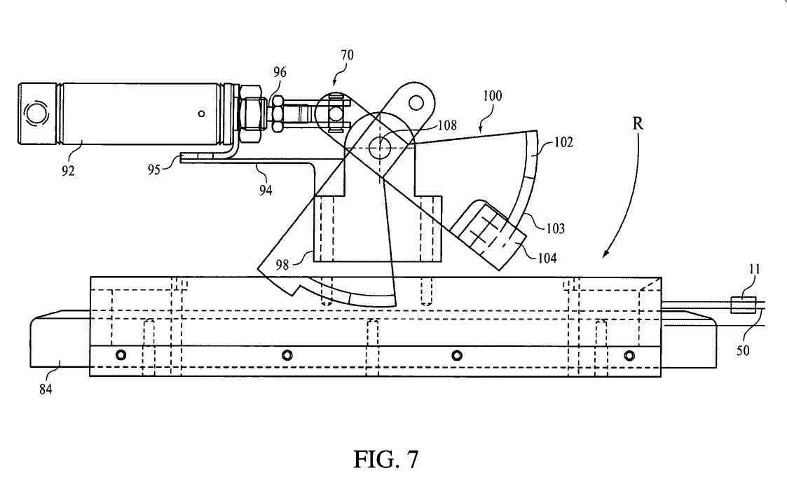

An alternate example embodiment of a closure mechanism opening apparatus 70 is illustrated in FIGS. 5-7. In this embodiment, the guide channel 78 and the blade 84 are designed and function in a similar manner as in the embodiment illustrated in FIGS. 3-4d. The closure mechanism opening apparatus 70 further comprises a piston 92, a brace 98, and a wedge 100. The piston 92 includes a rod 96 that may move in a selective reciprocating manner. In this embodiment, the wedge 100 is generally shaped as a sector of a circle as shown in FIG. 6a. The wedge 100 includes an arm 106 that extends from the corner of the sector that would otherwise correspond with the center of the circle from which the sector would be taken. The arm 106 includes an opening 108 through which a pin or rod may be inserted in such a way as to allow the wedge 100 to rotate around such a pin or rod. The arm 106 is operably connected to the rod 96 such that when the rod 96 is extended from the piston 92, the wedge 100 rotates, preferably in the direction of the arrow R shown in FIG. 7. Likewise, when the rod 96 is withdrawn, the wedge 100 will rotate in a direction opposite that in which it rotates when the rod 96 is extended. The wedge 100 is preferably attached to the channel 78 by a brace 98. In the embodiment illustrated in FIG. 5, the brace 98 includes an opening that may be aligned with the opening 108 through the wedge 100. In this way, a pin or rod that is inserted through the opening 108 also serves to attach the wedge 100 to the brace 98. The brace 98 is also preferably attached to the piston 92 by way of brackets 94, 95.

As best shown in FIG. 6b, the curved edge 102 of the wedge 100 is tapered so that its leading edge 101 narrows to a point. The curved edge 102 also includes a pair of guide members 104 that are adjacent the leading edge 101. Similar to the embodiment described above, and as shown in FIG. 7, a length of the closure mechanism material 50 that corresponds to the length of a resealable package 20 passes into the guide channel 78, on top of blade 84. The progress of the closure mechanism material 50 is stopped. The piston 92 is then actuated whereby the rod 96 is extended. This causes the wedge 100, including guide members 104, to rotate through an aperture (not shown) in the top of the guide channel 78. The guide members 104 are forced along the outside of the closure mechanism material 50, and the curved edge 102 of the wedge 100 is disposed between a portion of the length of the closure profiles. As the wedge 100 rotates, the curved edge 102 of the wedge 100 forces closure profiles to disengage. After the closure profiles disengage, the wedge 100 rotates in the opposite direction, thereby withdrawing from the closure mechanism material 50. As one skilled in the art will recognize, an alternate embodiment to that illustrated in FIGS. 5-7 would be a blade designed to rotate in a complete 360° arc as it passes through the closure mechanism to disengage the closure profiles. The opened closure mechanism material 50 is then advanced in an opened state for further processing, as is described below.

FIGS. 6 c-f illustrate an alternate embodiment of a wedge 200 for use with the opening apparatus 70, for example, as shown in FIG. 5. As described above, the various methods of opening a closure mechanism with the embodiment illustrated in FIGS. 5-7 may include both reciprocal and rotational movement of the wedge (100, 200). For example, reciprocal movement is such that the wedge enters the closure mechanism in one direction (e.g. “R” in FIG. 7) and, after opening the closure mechanism, is removed from the closure mechanism in the opposite direction.

Rotational movement of the wedge (100, 200) occurs by rotating the wedge (100, 200) with a controlled mechanical rotating device (not shown) such that the wedge moves in circular direction and passes into and out of the closure mechanism as the wedge (100, 200) scribes an arc at some aspect of circle “C” as depicted in FIG. 6e-f.

With reference to FIG. 6c, wedge 200 is shown consisting of a body 210, an opening plow 220 and guide legs 230, 232. As shown FIG. 6d, the plow 220 is preferably centered along a travel path “P” passing between guide legs 230, 232. This arrangement of the plow 220 with the guide legs 230, 232 facilitates the cooperation of these structures such that during operation the guide legs 230, 232 capture the closure mechanism and align the plow 220 to pass into the closure mechanism thereby opening the closure mechanism. It is preferable if the plow 220 has a tapered leading edge to facilitate its entry into the closed closure mechanism.

As further illustrated in FIGS. 6d-6f, the wedge 200 is preferably rotated into the closure mechanism material 50 to thereby separate (open) closure profiles 23, 25. After opening, the opened closure mechanism can be advanced for further processing (e.g. attachment, filling, etc.).

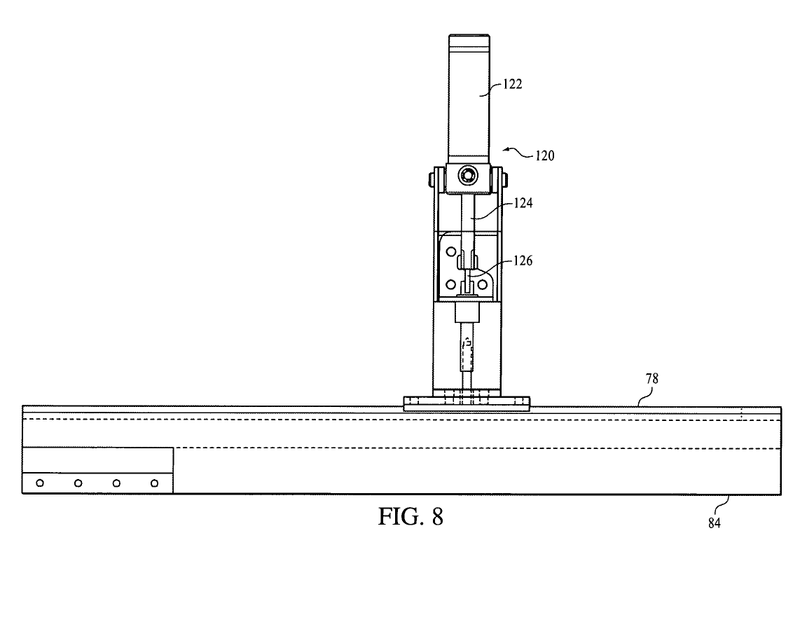

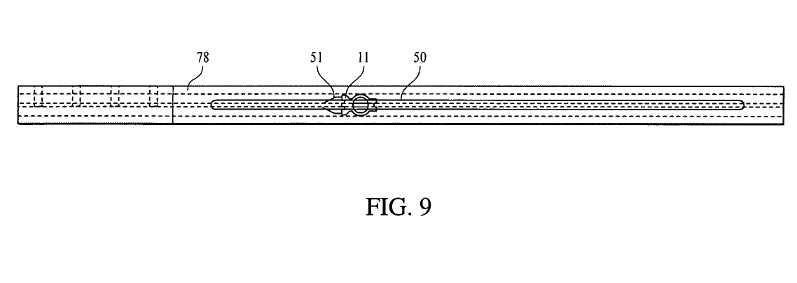

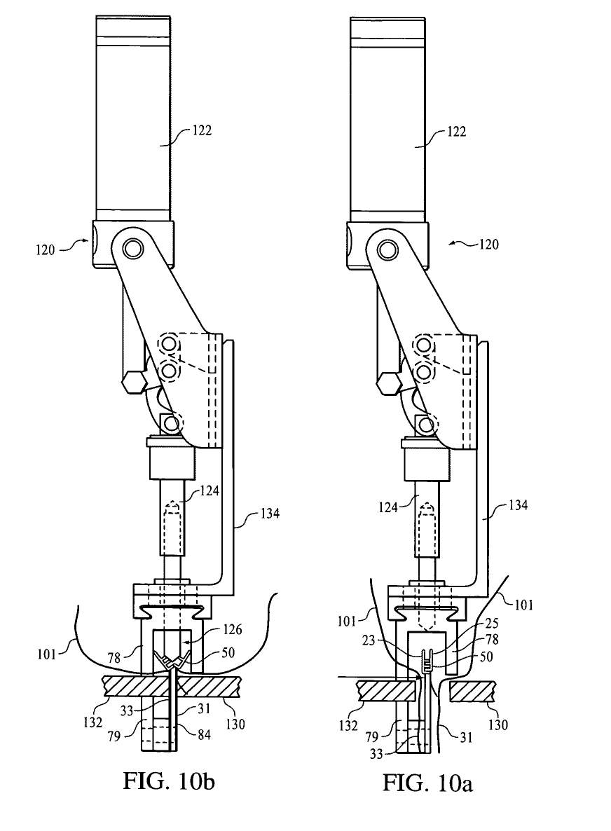

A further preferred embodiment of the invention is illustrated in FIGS. 8-10b. In this embodiment, the guide channel 78 and the blade 84 are designed and function in a similar manner as in the embodiments described above. In this embodiment, the channel 78 may also include an opening 79 (e.g. shown in FIGS. 10a-10b) through which a pair of sealing bars, 130, 132 may pass, as described below. In this embodiment, the closure mechanism opening apparatus 120 comprises a rod 124 and a piston 122 that causes selective reciprocating movement of the rod 124. A preferred rod 124 and piston 122 are manufactured again, by DE-STA-CO Industries.

In the embodiment illustrated in FIGS. 8-10b, the wedge 126 is generally cylindrical in shape, although one end may be tapered to facilitate opening of the closure mechanism material 50. The piston 122 and rod 124 are held in place above the guide channel 78 by brace 134.

This embodiment may take advantage of the fact that, when certain types of sliders 11 are attached to the closure mechanism material 50, a small opening 51 (as shown in FIG. 9) is created between the closure profiles 23, 25 immediately adjacent to the slider 11.

In operation, a length of the closure mechanism material 50 that preferably corresponds to the length of a resealable package 20 passes into the guide channel 78, on top of blade 84. The progress of the closure mechanism material 50 is stopped at a point when the opening 51 is directly beneath the wedge 126. The piston 122 is then actuated whereby the rod 124 is extended. This causes the wedge 126 to be moved through the top of the guide channel 78. The wedge 126 is disposed in the opening 51 between the closure profiles [23, 25].

Preferably, the guide channel 78 is aligned with sealing bars 130, 132 that are used to seal the side panels 31, 33 to the closure profiles 23, 25 such that the sealing bars 130, 132 may pass through the opening 79 in the guide channel 78. In this embodiment, it is preferred to have the sealing bars 130, 132 move together to seal the side panels 31, 33 to the closure profiles 23, 25 at substantially the same time that the wedge 126 is inserted into the opening 51. The sealing bars 130, 132 are then withdrawn from the guide channel 78. The closure mechanism material 50 is then advanced the length of one package 20 with the wedge 126 still inserted between the closure profiles 23, 25. As will be understood by one of ordinary skill in the art, this movement will cause the engaged portion of the closure mechanism material 50 to disengage. After the closure mechanism material 50 has been advanced, and thus disengaged along the length of one package 20, the wedge 126 is withdrawn from the closure mechanism material 50. The opened closure mechanism material 50 continues in an opened state for further processing, as is described below.

In the embodiments illustrated in FIGS. 3-7, the closure mechanism material 50 is opened, but not yet sealed to the side panels 31, 33. In the embodiment illustrated in FIGS. 8-10b, the closure mechanism material 50 is positioned between the side panels 31, 33. The side panels 31, 33 are then heat sealed to the closure profiles 23, 25 by sealing bars 130, 132. The various embodiments of this invention contemplate that opening of the closure mechanism 41 and sealing of the closure profiles 23, 25 to the side panels 31, 33 can occur either sequentially (e.g. opening followed by sealing or sealing followed by opening) or simultaneously (i.e. opening and sealing at the same station and substantially at the same time).

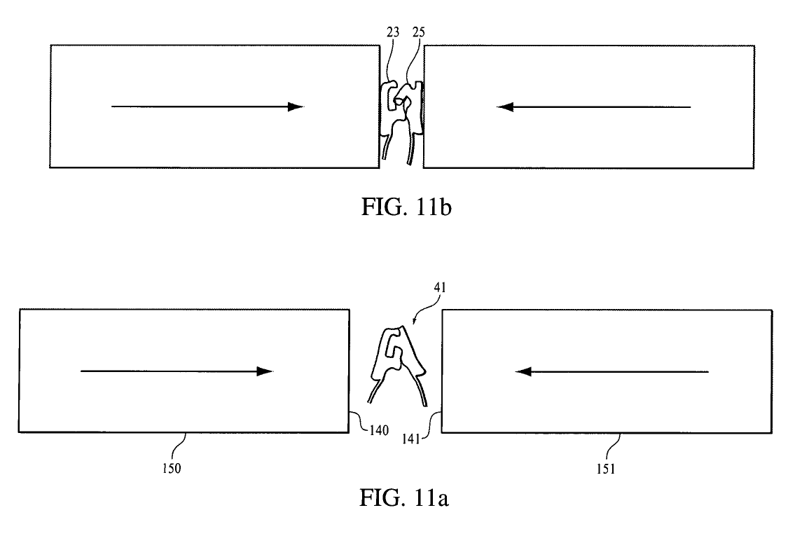

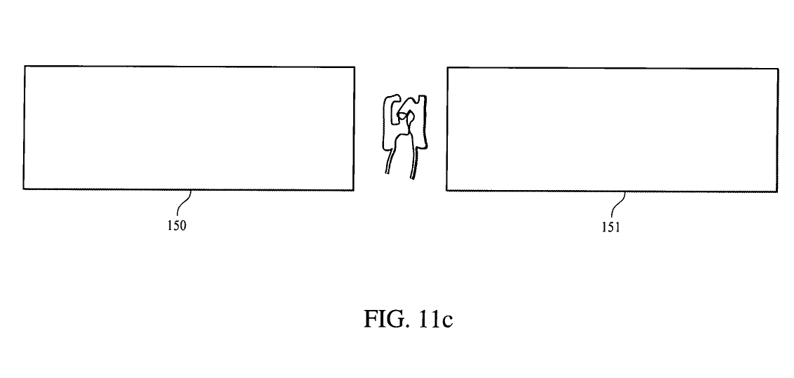

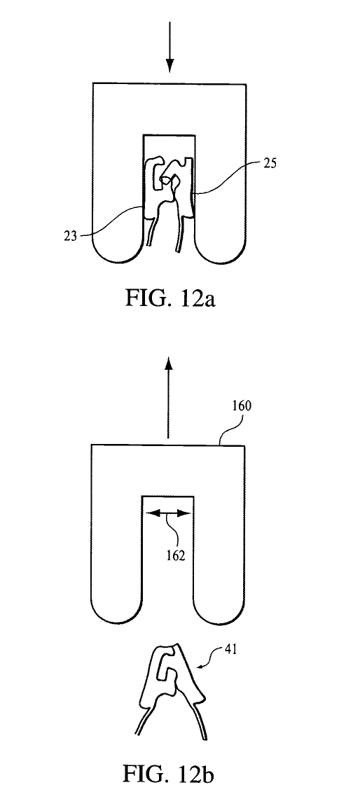

Two additional embodiments are schematically illustrated in FIGS. 11-12, each of which incorporates a force that is external to the closure mechanism 41 to open the closure profiles 23, 25. With reference to FIG. 11a, a cross-sectional view of an alternate closure mechanism 41 is shown in a closed or engaged position. The engaged mechanism 41 is positioned between two opposing flat surfaces 140, 141, on moveable wedges 150, 151. Upon activating the opening apparatus 70 illustrated in FIG. 11a, the moveable wedges 150, 151 move towards each other, as best shown in FIG. 11b, with sufficient force to “pinch” the closure profiles 23, 25 of closure mechanism 41 into an open position. The pinching occurs as surfaces 140, 141 come in contact with closure profiles 23, 25. Following this “pinch-open” action, the wedges 150, 151 move apart, as shown in FIG. 11c, and reset for admission of the next closure mechanism to be opened.

One of skill in the art will recognize many variations of practicing the invention illustrated in FIGS. 11a-11c. For example, one of the moveable wedges (150) could be replaced with an immovable surface such that only one moveable wedge (151) would have to move and pinch the closure mechanism against the immovable surface to open these closure profiles.

A further embodiment utilizing a force external to the closure mechanism to open the closure profiles is illustrated in cross-section in FIGS. 12a-b. In this embodiment, a channel wedge 160 is placed over closure profile 50 (FIG. 12a), such that said action of placement forces open the closure profiles 23, 25 (FIG. 12b). Preferably, the interior dimension 162 of the channel wedge 160 is proportioned appropriately to accomplish the opening of the closure profiles 23, 25 without disrupting the integrity of the package (not shown).

It is contemplated that the channel wedge embodiment operates in a substantially similar manner the method as previously described for the wedge illustrated in FIGS. 4a-4d. The main difference between these distinct embodiments is that the closure mechanism illustrated in FIGS. 4a-4d lends itself to being split-open by inserting a wedge between the closure profiles, while the closure mechanism of FIG. 12 is opened by a force applied externally to the closure profiles.

Referring back to FIG. 2, after opening the closure mechanism in accordance with the invention disclosed herein, the continuous line of packages continues to sealing bars 112 that seal the sides 31, 33 of the package 20. The continuous line of packages then pass under hopper 114 that contains the product to be placed in package 20. As the packages pass under the hopper 114, product 241 passes through the mouth of the header section 101 and into the interior of the package 20. In certain embodiments, the mouth of the header section 101 is then sealed by sealing bars 116 to form a tamper-evident structure. Finally, the continuous line of packages is separated into individual packages by cutting knife 118.

While specific embodiments and methods for practicing this invention have been described in detail, those skilled in the art will recognize various manifestations and details that could be developed in light of the overall teachings herein. Accordingly, the particular mechanisms disclosed are meant to be illustrative only and not to limit the scope of the invention which is to be given the full breadth of the following claims and any and all embodiments thereof.

What is claimed is:

1. A method for making a resealable package comprising:
(a) providing a closure mechanism, the closure mechanism comprising first and second closure profiles constructed and arranged to selectively engage and wherein the first and second closure profiles are engaged;
(b) providing first and second opposed panel sections comprised of a flexible polymeric material;
(c) inserting a wedge between the closure profiles;
(d) disengaging the closure profiles; and
(e) attaching the closure mechanism to the panel sections.

2. The method of claim 1, further comprising attaching a slider to the closure mechanism.

3. The method of claim 1, further comprising, after the disengaging step, attaching a slider to the closure mechanism.

4. The method of claim 1, wherein the attaching step occurs substantially simultaneously with the inserting and disengaging steps.

5. The method of claim 2, further comprising filling the resealable package with a product.

6. The method of claim 3, further comprising sliding the slider along the closure mechanism thereby engaging the closure profiles.

7. The method of claim 1, wherein the wedge has a length substantially the same as the length of the resealable package and wherein the step of disengaging the closure profiles comprises pushing the wedge into the engaged closure mechanism along the entire length of the wedge until the closure members disengage.

8. The method of claim 1, wherein the step of disengaging the closure profiles comprises pushing the wedge into the engaged closure profiles at an end of the closure mechanism until a portion of a length of the closure mechanism disengages; and moving the wedge along the length of the closure mechanism, thereby disengaging the engaged closure profiles.

9. The method of claim 8, wherein said moving of the wedge occurs as a sweep of an arc.

10. The method of claim 2, wherein the step of disengaging the closure profiles comprises inserting the wedge into the engaged closure profiles at an end of the closure mechanism until a portion of a length of the closure mechanism disengages; and moving the engaged portion of the length of the closure mechanism towards the wedge, such that as the closure mechanism is moved, the wedge disengages the remainder of the length of the closure mechanism.

11. The method of claim 2, wherein the slider is attached prior to the disengaging step and the wedge is inserted into the engaged closure profiles adjacent the slider.

12. The method of claim 9, wherein the wedge is inserted into the closure profiles substantially contemporaneously with the panels being attached to the closure mechanism.

13. The method of claim 1, wherein the attaching step occurs before the inserting step and disengaging step.

14. The method of claim 1, wherein the inserting step is replaced with the step of exerting force external to the closure mechanism.

15. The method of claim 14, wherein the force external to the closure mechanism is exerted by at least one moveable wedge having a substantially flat surface, said wedge contacting the closure mechanism with a flat surface.

16. The method of claim 14, wherein the force external to the closure mechanism is exerted by a channel wedge.

17. An apparatus for opening a closure mechanism of a resealable package, the closure mechanism comprising first and second closure profiles constructed and arranged to selectively engage, the apparatus comprising;
(a) a piston and a rod, said rod being in operable connection with a wedge;
(b) a guide channel aligned to guide the closure mechanism in proximity with the wedge; and
(c) means for activating said piston such that the piston moves the rod which functions to insert the wedge into the closure mechanism to thereby open the closure mechanism.

18. The apparatus of claim 17 wherein upon activation of said piston the rod is moved in a reciprocal and repetitive manner.

19. The apparatus of claim 17 further comprising a support blade in planer alignment with said wedge such that the closure mechanism is supported by the blade and aligned in proximity with the wedge.

20. The apparatus of claim 17 wherein the wedge further comprises guide members to align the closure mechanism in proximity with the wedge.

21. The apparatus of claim 17 wherein the wedge has a length substantially equal to the width of the resealable package.

22. The apparatus of claim 19 wherein the wedge has a general shape similar to a section of a circle.

23. The apparatus of claim 22 wherein the wedge further comprises an arm in rotatable connection with a brace such that upon activation of said piston the rod functions to rotate the wedge between the closure profiles of the closure mechanism.

24. The apparatus of claim 19 wherein the wedge is generally cylindrical in shape.

25. The apparatus of claim 24 wherein the wedge has an end that is tapered to facilitate its insertion into the closure mechanism.

26. The apparatus of claim 17 wherein the wedge is a channel wedge.

27. An apparatus for opening a closure mechanism of a resealable package comprising:
(a) a piston and a rod, said rod being in operable connection with a wedge;
(b) a guide channel aligned to guide the closure mechanism into adjacent proximity with the wedge; and
(c) means for activating the piston such that the piston moves the wedge in a perpendicular direction relative to the closure mechanism to thereby pinch-open the closure mechanism.

28. The apparatus of claim 27 further comprising sealing bars in parallel alignment with said wedge.

29. An apparatus for opening a closure mechanism of a resealable package, the closure mechanism comprising first and second closure profiles constructed and arranged to selectively engage, the apparatus comprising;
(a) a wedge having an opening plow and at least two guide legs, said plow being centered along a path of travel defined between the guide legs; and
(b) means for moving said wedge to insert the plow into the closure mechanism to thereby separate the closure profiles.

30. The apparatus of claim 29 whereby said means for moving said wedge operate in a rotational manner.

31. The apparatus of claim 29 whereby said means for moving said wedge operate in a reciprocal manner.
